(19) United States
(12) Patent Application Publication
(10) Pub. No.: US 2008/0052996 A1
(43) Pub. Date: Mar. 6, 2008

(54) MOVABLE BODY CONTROL APPARATUS

(75) Inventor: Takehiko SUGIURA, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/842,733

(22) Filed: Aug. 21, 2007

(30) Foreign Application Priority Data
Aug. 30, 2006 (JP) 2006-233366

(51) Int. Cl. E05F 15/20; B60J 5/00

(52) U.S. Cl. 49/28; 49/27

(57) ABSTRACT

A movable body control apparatus includes: a contact detector configured to detect a contact between a movable body and an object, the contact detector outputting a signal when detecting the contact therebetween; object-removable judging portion inputted with the signal and configured to distinguish the contact of the object against the movable body from a removable of the object from the movable body, and to judge the removable of the object, the distinction and judgment being implemented based upon a characteristic of variations in the signal outputted from the contact detector; and movement-controlling portion for automatically moving the movable body in the same direction as a direction in which the movable body is moving when the object-removable judging portion judges the removable of the object while the movable body is moving.

### CROSS REFERENCE TO RELATED APPLICATIONS

This application is based on and claims priority under 35 U.S.C. §119 with respect to Japanese Patent Application 2006-233366, filed on Aug. 30, 2006 the entire content of which is incorporated herein by reference.

### FIELD OF THE INVENTION

The present invention relates to a movable body control apparatus that controls an operation of a movable body in response to a contact of an object thereto.

### BACKGROUND

Recent vehicles, especially vehicle types such as vans and minivans, are mounted with an automatic door automatically opened and closed by an electric motor for example, which facilitates an occupant getting on and off and taking luggage in and out and so on (for example, see JP2004-150125A, JP2004-322725A).

It is necessary to avoid pinching an object at an automatic door operated for an opening/closing operation. Recent suggestions have conventionally led to providing a piezoelectric sensor at an edge of a door. The piezoelectric sensor is configured to detect a contact of an object against the door, and an entrapment of an object at the door is prevented based upon a detection of the piezoelectric sensor.

According to the disclosure in JP2004-316087A, driving means of a slide door is controlled to reverse a current moving direction of the slide door when object-detecting means, which is attached to a slide door, detects a contact of an object or that the object is not in contact anymore.

Conventional automatic doors are discontinued from moving for an opening/closing operation when a controller receives a signal of a contact sensor, and the automatic door is then moved in a reverse direction. For example, on an occasion where an opened door is controlled for a closing operation in a circumstance where an object is in contact with the opened door, even if the object is removed from the door or is not in contact with the door anymore immediately after the door starts moving for a closing operation, the door movement for the closing operation is discontinued and is changed to a door movement for an opening operation. Here, although the object is removed from the door and has not been pinched in this case, the door is unnecessarily moved for the opening operation. That is, an operator needs to control the door for a closing operation once more after the door movement for an opening operation is started.

A need thus exists for a movable body control apparatus, which is not susceptible to the drawback mentioned above.

### SUMMARY OF THE INVENTION

According to an aspect of the present invention, a movable body control apparatus includes a contact detector configured to detect a contact between a movable body and an object. The contact detector outputs a signal when detecting the contact therebetween. The movable body control apparatus further includes an object-removable judging portion inputted with the signal and configured to distinguish the contact of the object against the movable body from a removable of the object from the movable body, and to judge the removable of the object. The distinction and judgment are implemented based upon a characteristic of variations in the signal outputted from the contact detector. The movable body control apparatus still further includes a movement-controlling portion for automatically moving the movable body in the same direction as a direction in which the movable body is moving when the object-removable judging portion judges the removable of the object while the movable body is moving.

### BRIEF DESCRIPTION OF THE DRAWINGS

The foregoing and additional features and characteristics of the present invention will become more apparent from the following detailed description considered with reference to the accompanying drawings, wherein:

FIG. 1 is a block view illustrating a control apparatus of an automatic door according to a first embodiment of the present invention;

FIG. 2 is an outside view illustrating an example of a positional relationship between the automatic door and a contact sensor;

FIG. 3A is a time chart for explaining characteristics of a signal outputted from the contact sensor upon an impact of an object against the contact sensor;

FIG. 3B is a time chart for explaining characteristics of a signal outputted from the contact sensor upon a removable of the object from the contact sensor;

FIG. 4 is a flowchart for explaining an example of an operation for a closing operation of the automatic door;

FIG. 5 is an outside view illustrating an example of a positional relationship between a tailgate of a vehicle and the contact sensor;

FIG. 6 is a flowchart for explaining an example of an operation for a closing operation of the tailgate according to a second embodiment; and

FIGS. 7A and 7B are time charts for explaining characteristics of a signal outputted from a contact sensor which is different from the contact sensor in FIGS. 3A and 3B.

### DETAILED DESCRIPTION

Embodiments of the present invention will be described below with reference to the attached drawings.

### Embodiment 1

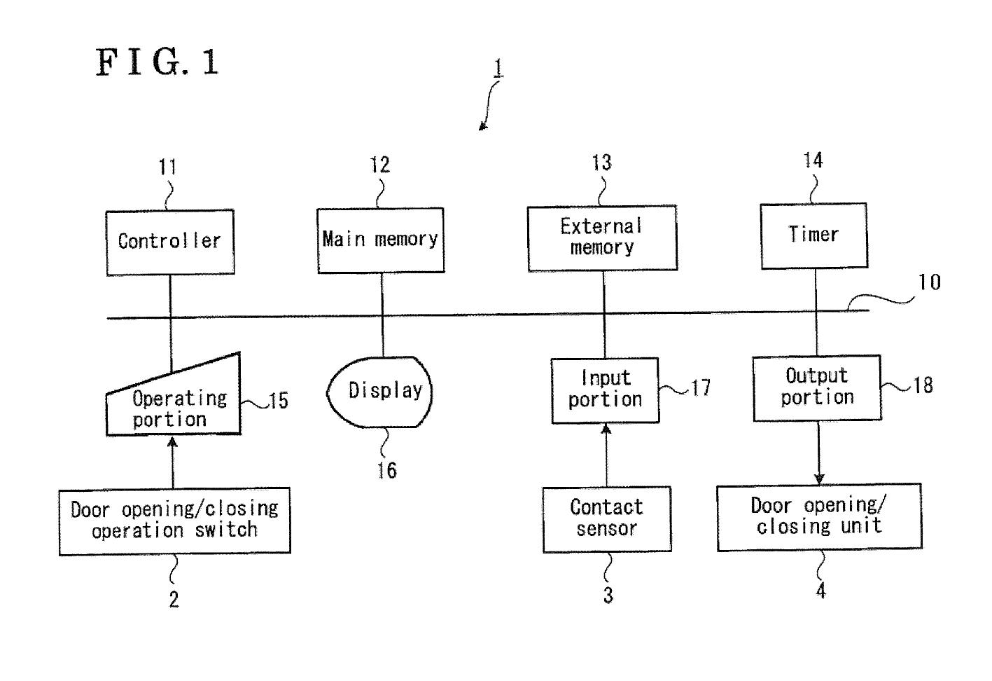

Described below is a movable body control apparatus according to a first embodiment of the present invention with reference to the attached drawing figures. FIG. 1 is a block view illustrating a movable body control apparatus 1 according to the first embodiment.

As illustrated in FIG. 1, the control apparatus 1 incorporates therein a controller 11, a main memory 12, an external memory 13, a timer 14, an operating portion 15, a display 16, an input portion 17, and an output portion 18. Connected to the controller 11 via an internal bus 10 are the main memory 12, the external, memory 13, the timer 14, the operating portion 15, the display 16, the input portion 17, and the output portion 18.

The controller 11 is configured with a CPU (Central Processing unit). The programs stored in the external memory 13 render the controller 11 to be inputted with a signal outputted from a contact sensor 3 serving as a contact detector and to implement processes for operating a door opening/closing unit 4 serving as a movable body-operating portion.

The main memory 12 is configured with a RAM (Random-Access Memory) and so on. The RAM is loaded with the programs stored in the external memory 13 and contributes as a workspace of the controller 11.

The external memory 13 is configured with a non-volatile memory such as a ROM (Read Only Memory), a flash memory device, a hard disc, a DVD-RAM (Digital Versatile Disc Random-Access Memory), a DVD-RW (Digital Versatile Disc Rewritable) or the like. The external memory 13 is pre-stored with programs by which the controller 11 implements processes. Further, in accordance with a command of the controller 11, the external memory 13 supplies, to the controller 11, data stored in each program and memorizes therein data supplied by the controller 11.

The timer 14 is configured with a pulse generator, which generates clock (electric) pulses at the same time-intervals, a counter, or the like. In accordance with a command of the controller 11, the timer 14 starts counting the number of electric pulses and reads out, from the controller 11, a value of the counter at a certain time point. Further, the timer 14 starts subtracting the value of the counter. When the value of the counter turns to zero, the timer 14 outputs an interrupting signal to the controller 11.

The operating portion 15 includes a key switch, a jog dial, an interface, which connects the key switch and/or the jog dial to the internal bus 10, and the like. A command of an operator opening or closing an automatic door is inputted to the controller 11 via the operating portion 15. The operating portion 15 is connected to a door opening/closing operation switch 2 mounted on a vehicle. The door opening/closing operation switch 2 may be a radio remote controller (wireless remote controller).

The display 16 includes for example an LCD (Liquid Crystal Display) of a navigation system of a vehicle and displays therein a position, an operation state, of the door, and so on. The display 16 may be attached with a buzzer or a loud speaker, so that, an operator can be warned by a sound or by a voice that the door impacts an object during the opening/closing operation and is stopped from moving or reversed to an original position.

The input portion 17 includes a serial interface, or a LAN (Local Area Network) interface, connected to the contact sensor 3. The contact sensor 3, which serves as the contact detector, may be for example a piezoelectric sensor arranged at an edge (peripheral edge) of a door and has flexibility. The piezoelectric sensor detects a contact of an object against a door. Alternatively, the contact sensor 3 may be a current detecting sensor, which calculates a level of electric current supplied to an electric motor configured to drive a door. The current detecting sensor detects a contact of an object at the door based upon fluctuations in electric current being supplied to the electric motor, electric current which fluctuates in response to an entrapment of an object between a vehicle body and a vehicle door.

The output portion 18 includes serial interface, or a LAN (Local Area Network) interface, connected to the door opening/closing unit 4 as a movable body-operating portion. The controller 11 outputs a signal, which represents a command of a door opening/closing operation, to the door opening/closing unit 4 via the output portion 18. Further, the controller 11 receives a signal from the door opening/closing unit 4, signal which represents a termination of a door opening/closing operation.

The door opening/closing unit 4 is adapted to operate for example a slide door or a swing-type tailgate by an electric motor. As additional functions, the door opening/closing unit 4 may detect a fully opened state and a fully closed state of a door by use of a limit switch and send a message to the control apparatus 1, informing that the opening/closing operation of the door is completed.

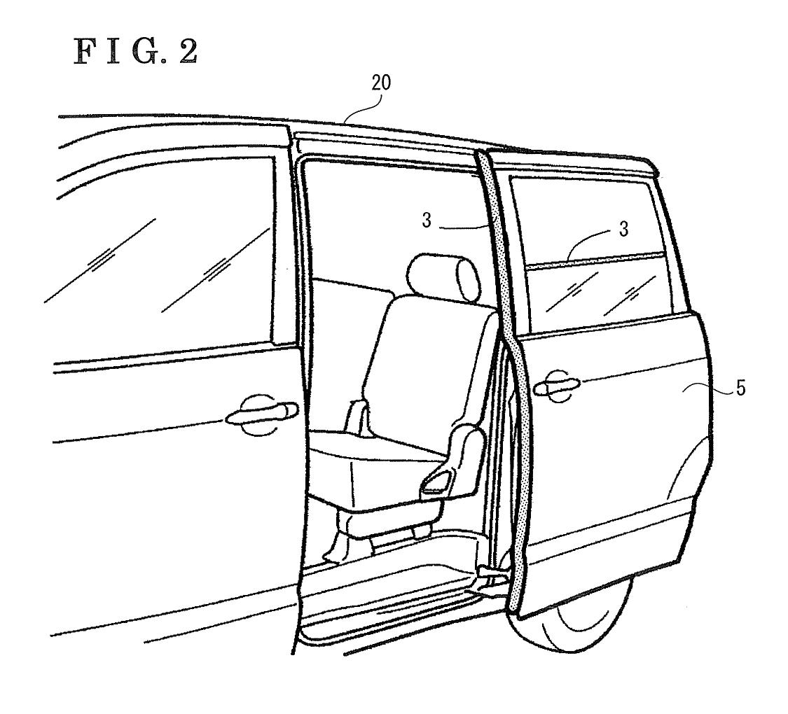

As illustrated in FIG. 2, a vehicle 20 is mounted, at its side plane, with a slide door 5 as an automatic door and a movable body. The slide door 5 moves in front and rear directions of the vehicle 20 while protruding laterally therefrom so that the opening of the vehicle 20 is opened and closed.

The contact sensor 3 is attached to the slide door 5 along a front vertical edge of the slide door 5. The contact sensor 3 is for example a piezoelectric sensor, which is flexible for measuring an amount of force applied thereto. A piezoelectric sensor includes a center electrode, a piezoelectric layer, an outer electrode and a cover, which are all laminated in a coaxial manner so that the piezoelectric sensor is formed into a cable shape. When the piezoelectric layer is caused to deform at a certain speed, a voltage potential difference is generated between the central electrode and the outer electrode, and the piezoelectric sensor outputs an electrical signal, which corresponds to for example the voltage potential difference concerned. More specifically, when an object impacts the piezoelectric sensor, the piezoelectric layer is deformed or compressed and a voltage is generated. On the other hand, when an object in contact with the piezoelectric sensor is being removed from the piezoelectric sensor or has been removed therefrom, the piezoelectric layer extends to its original shape. In this case, a voltage is generated, which varies in an opposite polar direction to the voltage generated upon the impact of the object. The controller 11, which serves as an object-removable judging portion, distinguishes a presence or absence of a contact, or a removable, of an object by being inputted with a signal electrically produced from the voltage concerned. Here, “removable” includes at least two situations: an object in contact with the sensor is being removed from the sensor and may be partially in contact with the sensor; and the object, which was in contact with the sensor, has been removed from the sensor and is not in contact with the sensor anymore. When an object impacts a front edge of the slide door 5, to which the contact sensor 3 is attached, the contact sensor 3, which is a piezoelectric sensor for example, outputs an electrical signal representing a presence of a contact.

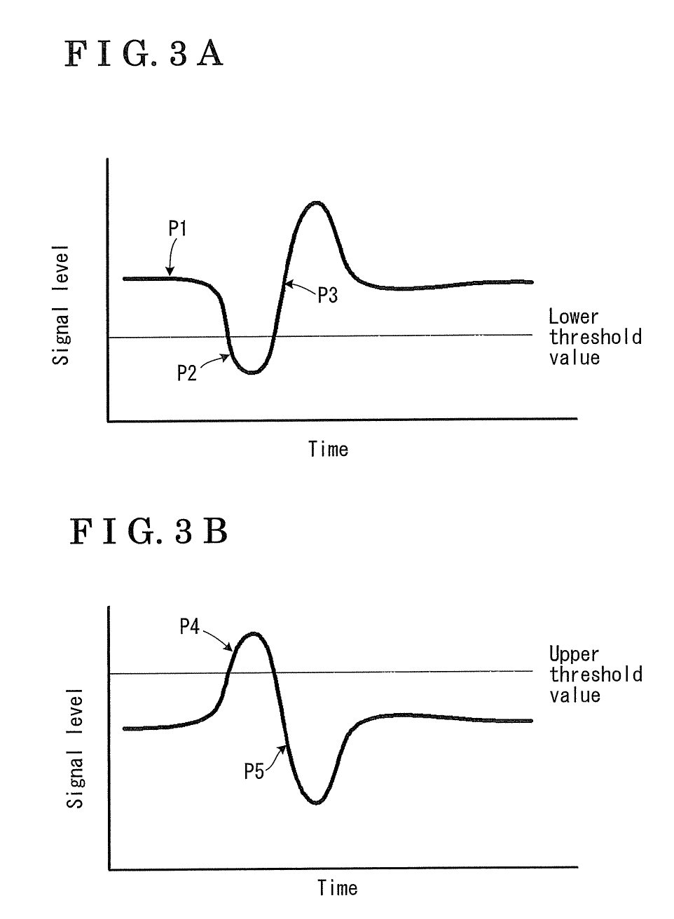

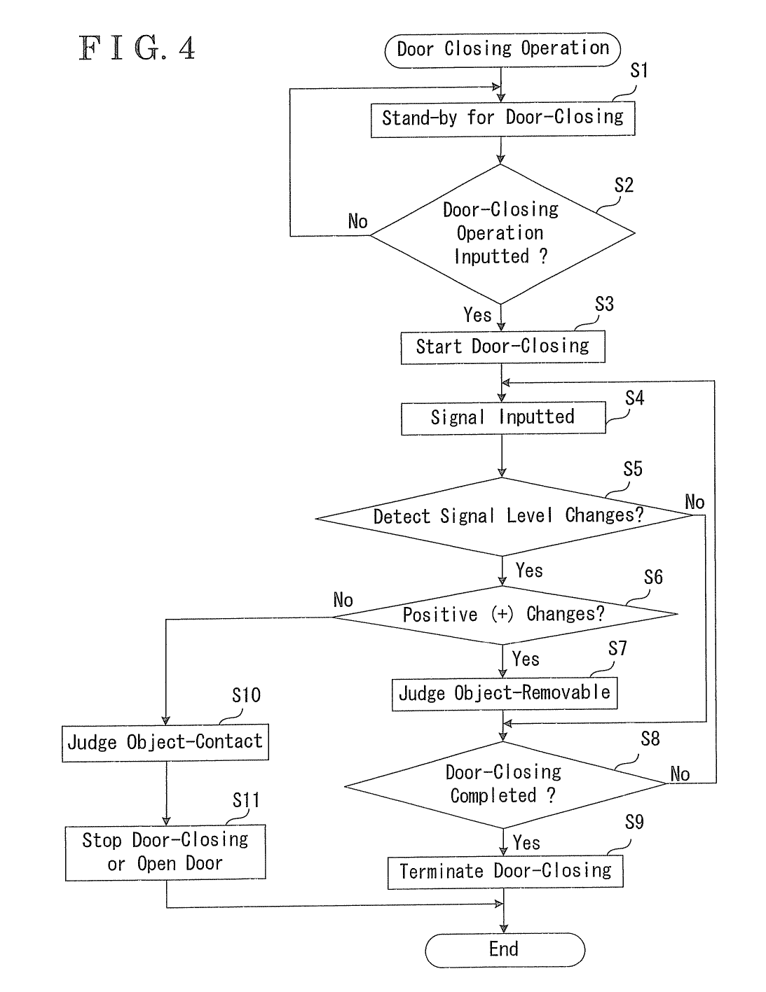

Described below is an operation of the control apparatus 1 in FIG. 1 to move the slide door 5 for an opening/closing operation, with reference to FIGS. 3 and 4. As described above, the control apparatus 1 operates with the controller 11 activated in association with the main memory 12, the external memory 13, the timer 14, the operating portion 15, the display 16, the input portion 17, the output portion 18, the contact sensor 3, and the door opening/closing unit 4.

FIG. 3A is a time chart for explaining characteristics of a signal outputted from the contact sensor 3 when an object impacts the contact sensor 3, and FIG. 3B is a time chart for explaining characteristics of a signal outputted from the contact sensor 3 when an object, which is in contact with the contact sensor 3, is being removed from the contact sensor 3 and when the object, which was in contact with the contact sensor 3, has been removed from the contact sensor 3 and/or is not in contact with the contact sensor 3 anymore. As being explained in FIG. 3A, where no load is applied to the contact sensor 3, a level of signal, which is outputted from the contact sensor 3, is at an equalized level as denoted by P1. The level of signal corresponds to an actual voltage (potential difference) and is hereinafter referred to as a signal level. In FIGS. 3A and 3B, the horizontal axis is the time and the vertical axis is a signal level. As is apparent from FIG. 3A, where the contact sensor 3 is compressively deformed due to an impact with an object, the signal level of the contact sensor 3 is no longer maintained at an equalized level and varies to a negative level as denoted by P2. The signal level then varies to a positive level as denoted by P3. That is, in an occasion where an object impacts the contact sensor 3, a signal level of the output signal of the contact sensor 3 varies a positive level after the signal level varies to a negative level from the equalized state. Here, the variations of the signal level to a positive level include an increase in the signal level, while the variations of the signal level to a negative level include a decrease in the signal level. The controller 11 determines the presence of an impact of an object onto the contact sensor 3 in a situation where the above-described characteristics of the signal level appear and where the signal level falls below a predetermined lower threshold level.

On the other hand, as is apparent from FIG. 3B, where an object in contact with the contact sensor 3 is being removed from the contact sensor 3 and/or where an object, which was in contact with the contact sensor 3, has been removed from the contact sensor 3, a voltage (signal level) of the output signal of the contact sensor 3 varies to a positive level (denoted by P4) and then to a negative level (denoted by P5). The controller 11 determines the presence of a removable of an object from the contact sensor 3 in a situation where the above-described characteristics of the signal level appear and where the signal level exceeds an upper predetermined threshold level.

A level of the output signal of the contact sensor 3 depends on characteristics, and a detection circuit structure, of the contact sensor 3. However, whichever the characteristics, and the detection circuit structure, of the contact sensor 3 are, the signal outputted from the contact sensor 3 upon an impact of an object onto the contact sensor 3 exhibits characteristics of its variations that are opposite to the ones of the signal outputted upon a removable of an object.

The characteristics of variations in the signal transmitted from the contact sensor 3 into the controller 11 are employed by the controller 11 to judge whether it is a contact, or a removable of an object. When the controller 11 recognizes a signal, which represents a that an object is being removed or has been removed from the slide door 5 during an opening/closing operation of the slide door 5 by the door opening/closing unit 4, the controller 11 controls the door opening/closing unit 4 to continue the opening/closing operation of the slide door 5 without ceasing the current opening/closing operation.

FIG. 4 is a flowchart explaining an example of an operation of the slide door 5 moved for a door closing operation.

As being explained in FIG. 4, in step S1, the controller 11 is in a standby mode, waiting for an input for moving the slide door 5 for a closing operation. In step S2, when the door opening/closing operation switch 2 is operated and an operation for closing the slide door 5 is inputted to the controller 11 from the operating portion 15, an affirmative answer “Yes” is obtained in step S2. The program then proceeds to step S3. When a negative answer “No” is obtained in step S2, the program returns to step S1. In step S3, the controller 11 commands the door opening/closing unit 4 to operate the slide door 5 for a closing operation. In step S4 (step of detecting a contact), the controller 11 is inputted with a signal outputted from the contact sensor 3.

In step S5, the controller 11 judges changes in the signal level of a signal outputted from the contact sensor 3. When there is no change in the signal level of the output signal, the program proceeds to step S8. In step S8, the controller 11 judges whether the closing operation of the slide door 5 is completed. When the closing operation of the slide door 5 is not completed (“No” in step S8), the program returns to step S4, and the controller 11 is again inputted with an output signal of the contact sensor 3. Steps S4, S5 and S8 are repeatedly implemented until the closing operation of the slide door 5 is completed. Here, the controller 11 serves as a movement-controlling portion. When the closing operation of the slide door 5 is completed, an affirmative answer “Yes” is obtained in step S8. The program then proceeds to step S9, in which the controller 11 controls the door opening/closing unit 4 to terminate the closing operation of the slide door 5. The processes in steps S4, S5, S8, and S9 are implemented in the manner described above when the slide door 5 is to be closed with no impacting object with no impacting object/with no impact of an object. Further, even when the controller 11 recognizes slight changes in the signal level of a signal outputted from the contact sensor 3 in step S5, the controller 11 judges the absence of variations in the signal level unless the signal level exceeds the upper threshold level or falls below the lower threshold level.

As described above, according to the first embodiment of the present invention, the controller 11 employs, in Step S5, the signal level of the signal outputted from the contact sensor 3 as the first judgment of the presence or absence of the impact of the object. Alternatively, the controller 11 can employ any other parameters that are associated with characteristics of variations in the signal outputted from the contact sensor 3.

When the controller 11 judges or determines variations in the signal level of the signal outputted from the contact sensor 3 in step S5, an affirmative answer “Yes” is obtained in step S5. The program proceeds to step S6, in which the controller 11 judges whether the signal level varies to a positive level or increases and exceeds the upper threshold level. When the controller 11 judges the signal level varies to a negative level or decreases and falls below the lower threshold level, a negative answer “No” is obtained in step S6 and the program proceeds to step S10. In step S10, the controller 11 determines an impact of an object onto the contact sensor 3. In step S11, the controller 11 controls the door opening/closing unit 4 to cease the operation of the slide door 5 for a closing operation. Alternatively, in step S11, the controller 11 may control the door opening/closing unit 4 to move the slide door 5 for an opening operation. The controller 11 warns of such impact to an operator (driver) by displaying a certain warning on the display 16.

On the other hand, when the controller 11 judges, in step S6, the signal level varies to a positive level or increases and exceeds the upper threshold level, an affirmative answer “Yes” is obtained in step S6 and the program proceeds to step S7. In step S7 (step of judging a removable of an object), the controller 11 judges or determines that an object is being removed or has been removed from the slide door 5 and continues the closing operation of the slide door 5. In step S8 (step of automatically moving the movable body), the controller 11 judges whether the closing operation of the slide door 5 is completed. When the closing operation of the slide door 5 is not completed in step S8 (“No” in step S8), the program returns to step S4 and the controller 11 is again inputted with a signal by the contact sensor 3. As a result, the controller 11 automatically drives the door opening/closing unit 4 to operate the slide door 5 for a closing operation. Here, “automatically” defines that the closing operation of the slide door 5 is implemented without operating the door opening/closing switch 2 once again. When the closing operation is completed in step S8 (“Yes” in step S8), the program proceeds to step S9, in which the controller 11 controls the door opening/closing unit 4 to terminate the movement of the slide door 5 for a closing operation.

As described above, according to the first embodiment, the controller 11 judges a contact or a removable based upon characteristics of variations in a level of a signal outputted from the contact sensor 3. Further, when the polarities of the signals from the contact sensor 3 are different according to a contact, or a removable, of an object, the controller 11 may judge a contact, or a removable, of an object based upon the polarities of the signals. For example, a signal outputted from the contact sensor 3 upon an impact of an object against the slide door 5 exhibits an opposite polarity to a signal outputted upon a removable of an object from the slide door 5. In this case, the contact or removable of an object is determined based upon the polarity of the signal. Here; the definition “opposite polarity” intends to mean that the signal associated with a contact varies in a polar direction and the signal associated with a removable varies in an opposite polar direction. That is, in a situation where the polarity of the signal of the contact sensor 3 varies from an equilibrium state to a negative polarity and where the signal level falls below the lower threshold level, the controller 11 judges a contact of an object against the contact sensor 3. On the other hand, in a situation where the polarity of the signal of the contact sensor 3 varies from an equilibrium state to a positive polarity and where the signal level exceeds the upper threshold level, the controller 11 judges that an object is being removed, or has been removed, from the contact sensor 3.

As described above, the control apparatus 1 continues operating the slide door 5 in a closing direction in a case where an object in contact with the slide door 5 is being removed or has been removed therefrom. Therefore, there is no need to repeat again operating the slide door 5 in a closing direction. Further, when an object again makes a contact with the slide door 5 after being removed therefrom, the control apparatus 1 detects the contact and stops the door opening/closing unit 4 from operating the slide door 5 in a closing direction. Therefore, it is possible to ensure a safety level of the slide door 5.

### Embodiment 2

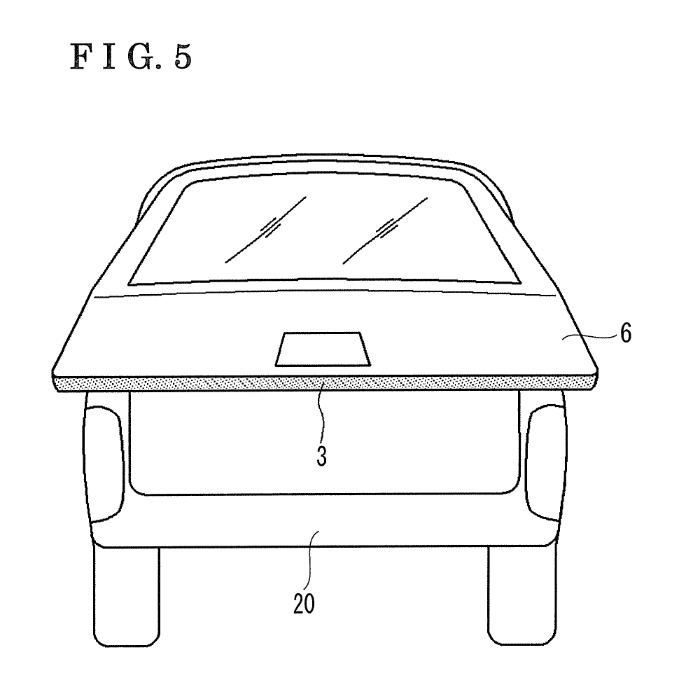

A movable body control apparatus according to a second embodiment of the present invention will be described hereinbelow with reference to the attached drawing figures. The movable body control apparatus is applicable for use in operating a rear door (tailgate/hatch) of a vehicle. As illustrated in FIG. 5, a tailgate/hatch or back door 6 (serving as an automatic door and a movable body) is provided at a rear of a vehicle 20. The tailgate 6 is an automatic door pivoted with a pivot axis at an upper edge thereof and opens and closes a rear opening of the vehicle 20.

The contact sensor 3 is attached to the other peripheral edge in parallel to the upper edge of the tailgate 6. The contact sensor 3 is for example a cable-shaped piezoelectric sensor having flexibility. When an object impacts the edge attached with the contact sensor 3, the contact sensor 3, which is a piezoelectric sensor for example, outputs a signal representing an impact of an object.

Although the tailgate 6 according to the second embodiment operates in a different way from the automatic door according to the first embodiment, the closing operation or movement of the tailgate 6 is continued when an object in contact with the tailgate 6 is being removed or has been removed therefrom, which is the same as the operation of the first embodiment. The structure of the control apparatus 1 is identical to the one of the first embodiment. In a case where a piezoelectric sensor is employed as the contact sensor 3 of the second embodiment, an impact, and a removable, of an object are detected in the same way as the first embodiment.

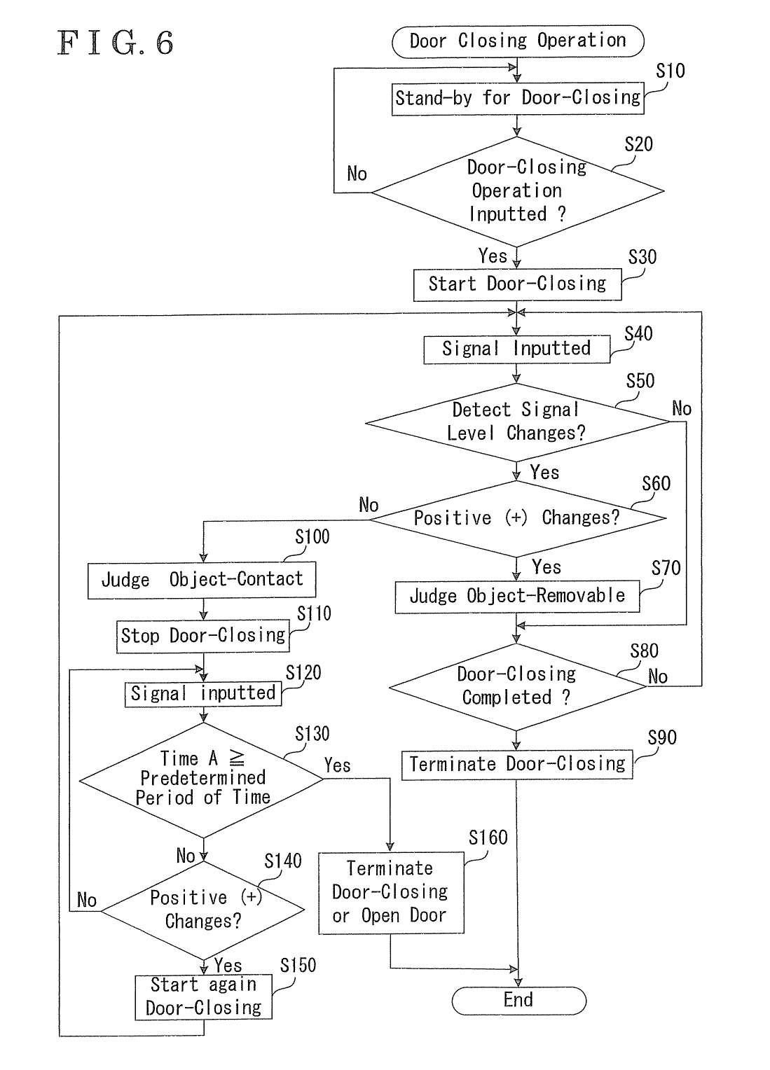

FIG. 6 is a flowchart for explaining an example for operating the tailgate 6 to close the rear opening of the vehicle 20. Steps S10 to S90 of the flowchart in FIG. 6 are the same as steps S1 to S9 in FIG. 4 according to the first embodiment. According to the second embodiment, when the controller 11 judges an impact of an object, the controller 11 controls the door opening/closing unit 4 to cease a closing operation of the tailgate 6 (see step S100). Meanwhile, when the controller 11 judges a removable of an object from the tailgate 6 after the impact of the object, the controller 11 controls the door opening/closing unit 4 to restart operating the tailgate 6 for a closing operation (see steps S100 to S150).

That is, when the controller 11 judges the signal level varies to a negative level or decreases and falls below the lower threshold level, a negative answer “No” is obtained in step S6 and the program proceeds to step S100. In step S100, the controller 11 judges an impact of an object onto the tailgate 6. In step S110, the controller 11 controls the door opening/closing unit 4 to cease the closing operation of the tailgate 6. Here, the timer of the control apparatus 1 initiates counting a period of time since the closing operation has ceased. In step S120 (step of detecting a contact), the controller 11 is further inputted with a signal from the contact sensor 3. In step S130, the controller 11 judges whether the period of time counted by the timer 4 (time A) is greater than, or equal to, a predetermined period of time. When the period of time counted by the timer 14 is less than the predetermined period of time, a negative answer “No” is obtained in step S130 and the program proceeds to step S140. In step S140 (step of judging a removable of an object), the controller 11 judges whether the polarity of the signal of the contact sensor 3 is changed to a positive side and a signal level exceeds the upper threshold level. Until the polarity of the signal of the contact sensor 3 is changed to a positive side and a signal level exceeds the upper threshold level, the controller 11 does not determine that an object is removing or has been removed from the tailgate 6. Therefore, the program returns to step S120, and the signal is inputted from the contact sensor 3 to the controller 11. In an occasion where the polarity of the signal is changed to a positive side and the signal level exceeds the upper threshold level before the predetermined period of time passes, the program proceeds to step S150 from step S140. In step S150 (step of automatically moving the movable body), the controller 11 automatically starts again driving the door opening/closing unit 4 to operate the tailgate 6 to close the rear opening of the vehicle 20. On the other hand, when the predetermined period of time passes in step S130, the program proceeds to step S160. In step S160, the controller 11 terminates the door closing operation or operates the tailgate 6 reversely for an opening operation.

As described above, according to the second embodiment, the door closing operation is ceased when an object impacts the tailgate 6 during the door closing operation. When the object is removed from the tailgate 6 after that, the door closing operation is resumed. Therefore, in such circumstances, when a user notices an impact of the object, such as an obstacle, on the tailgate 6 and gets rid of the object from the tailgate 6, the closing operation of the tailgate 6 is started again. Accordingly, there is no need to implement again an operation for closing the tailgate 6.

The above-described operation of the door 6 is effective for the case of opening an automatic door. For example, the contact sensor 3 is attached to a rear edge of the slide door 5. Even when an object impacts the contact sensor 3 during the opening operation of the slide door 5, the door opening operation is continued as far as the object is being removed or has been removed therefrom. As described above, the movable body control apparatus according to the first and second embodiments of the present invention is applicable not only for a door closing operation but also for a door opening operation.

The control apparatus 1 with the above-described structure and function more effectively implements the processes in a case where the control apparatus 1 initiates the closing operation of the tailgate 6 when the tailgate 6 is pushed downwardly while the tailgate 6 is being closed from an opened state, i.e., in a case where the door opening/closing switch 2 is operated when the tailgate 6 is pushed downwardly.

In this case, when a hand of a user grabs the rear or lower edge of the tailgate 6, the controller 11 judges that an object, here a hand of a user for example, is in contact with the contact sensor 3. When the hand is taken off from the tailgate 6 after pushing the tailgate 6 downward, the controller 11 judges that the object, which is in contact with the contact sensor 3, has been removed. As for this sort of case, according to a conventional control of an automatic door, the door closing operation is ceased or a door opening operation is started, and a user then needs to start again the door closing operation. The user may obtain an inconvenient feeling especially when taking luggage in and out. Meanwhile, according to the second embodiment of the present invention, the door closing operation is continued when the hand is taken off the rear edge of the tailgate 6 after starting the closing operation. Therefore, the door closing operation is implemented smoothly without operating the door opening/closing switch 2 once more.

Described above is the control apparatus 1 of a movable body, by taking the slide door 5 and the tailgate 6 of a vehicle as examples. The movable body control apparatus 1 is applicable not only to the slide door 5 and the tailgate 6 described above but also to open and close a trunk lid, a lifting window, a sunroof, an opening wing for a luggage, and so on. The movable body control apparatus 1 is further applicable to lift up and down an electrically driven window.

### Variations of First and Second Embodiments

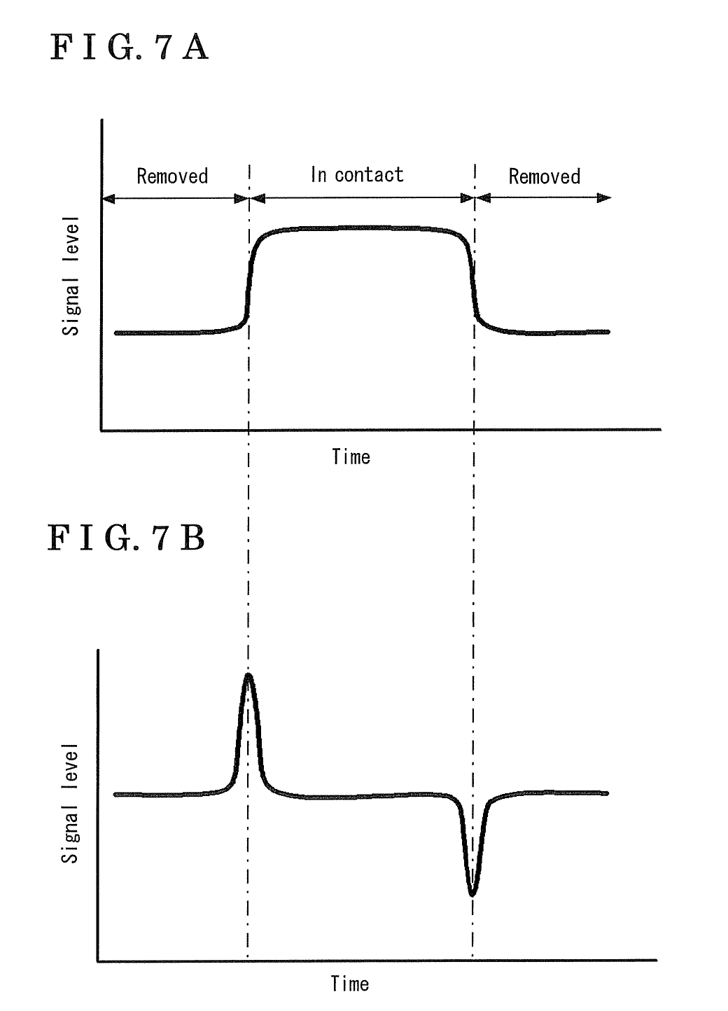

FIGS. 7A and 7B are time charts, each explaining characteristics of a signal outputted from the contact sensor 3 in a situation where a different type of sensor is employed as the contact sensor 3. Here, the contact sensor 3 includes multiple electrodes facing each other. When at least one of the electrodes is applied with load upon an impact of an object onto the sensor 3, the electrodes make a contact with each other and are electrically conducted. In this case, the contact sensor 3 detects an impact of an object.

As illustrated in FIGS. 7A and 7B, a signal level of the contact sensor 3 is increased to a voltage potential at the side of a power source in response to an impact of an object, while the signal level is decreased to a voltage potential at the side of an earth connection in response to a removable of the object. Contrarily, the contact sensor 3 may be designed in a manner that a signal level is decreased in response to an impact of an object, while the signal level is increased in response to a removable of the object. Whichever the contact sensor 3 is structured, the controller 11 distinguishes an impact and a removable, of an object based upon a level of a signal outputted from the contact sensor 3. In this case, the controller 11 may determine an impact or removable based upon a signal level. Alternatively, as illustrated in FIG. 7B, the controller 11 may determine an impact or removable based upon a polarity of a pulse generated where a level of a signal differentiated varies.

An electric current, which is supplied to a motor to operate an automatic door, may be employed as a sensor that detects an impact, and a removable, of an object based upon a signal level, as illustrated in FIGS. 7A and 7B. When an object impacts the automatic door, a resistance force against the operation of the automatic door is increased such that electric current to be supplied to the motor is increased. Meanwhile, when the object is being removed or has been removed from the automatic door, electric current supplied to the motor is reduced. As described above, it is possible to detect an impact, and a removable, of an object based upon a level of electric current supplied to the motor of an automatic door opening/closing apparatus.

In an occasion where the controller 11 judges a removable of an object based upon an amount of electric current supplied to the electric motor after starting a closing/opening operation, the controller 11 continues the closing operation. This is applicable not only to a slide door of a vehicle but also a rear door, a trunk lid, a lifting window, a sunroof, a opening/closing wing for a luggage, and so on. That is, this is applicable for any of the opening/closing body mounted on a vehicle.

As described according to the first and second embodiments, the movable body control apparatus continues an operation of a movable body when an object is being removed or has been removed. Therefore, there is no need to operate again. Further, when an object impacts the movable body after the removable of the object, the control apparatus detects the impact and stops the operation of the movable body. Therefore, it still ensures a safely level of the movable body operation. Still further, when a removable of an object is detected when the operation of the movable body is stopped due to an impact of an object against the movable body, the operation of the movable body is started again. When an operation notices an impact and gets rid of the object during the operation of the movable body, the operation of the movable body is started again. Therefore, there is no need to operate again.

The configurations of the hardware and the flowcharts are examples and can be optionally modified as needed.

A main system for implementing a door closing/opening operation does not have to be a system exclusive for the control apparatus 1 which incorporates therein the controller 11, the main memory 12, the external memory 13, the timer 14, the operating portion 15, the input portion 17, the output portion 18, the internal bus 10 and so on. The main system for the door closing/opening operation may be a computer system that has been normally used. For example, the control apparatus 1 may be configured in a manner that computer programs for implementing the above-described operation are stored and distributed into storage medium (flexible disc, CD-ROM, DVD-ROM or the like) to which the computer makes an access, and the computer programs are installed into the computer so as to be implemented for the door closing/opening operation. Further, the control apparatus 1 may be configured in a manner that computer programs are stored into storage mediums, which are incorporated into a communication network, such as Internet, and a normal computer system downloads the programs.

When the function of the controller 1 is achieved by an operating system (OS) and application programs, which are independent from each other, or by an combination of an operating system (OS) and application programs, only the application programs may be stored in the storage mediums or a memory devices.

Still further, it is possible to superposing computer programs on signal carriers and to distribute the programs via a communication network. For example, the computer programs may be stored in a BBS (Bulletin Board System) on a communication network, BBS to which a user can log in, and the programs may be distributed via the communication network. The computer programs may be activated and implemented in the same manner as the other application programs under the control by the OS.

The contact detector may be a piezoelectric sensor having flexibility and arranged at an edge or a peripheral edge of the movable body.

The object-removable judging portion may distinguish-a contact, or a removable, of an object based upon a polarity of a signal of the contact detector. Especially, the object-removable judging portion judges the removable of the object when the signal varies in a polar direction, the polar direction which is opposite to a polar direction in which the signal varies upon the contact.

The movable body may be at least one of a slide door, a rear door, a trunk lid, a lifting window, a sunroof and an opening wing for a luggage.

According to the movable body control apparatus described above, the operation of the movable body is continued when an object is being removed or has been removed from the movable body. Therefore, it is possible to supply the movable body control apparatus, which ensures a safely level for the operation of the movable body and is convenient because it does not need a complicated operation.

The principles, of the preferred embodiment and mode of operation of the present invention have been described in the foregoing specification. However, the invention, which is intended to be protected, is not to be construed as limited to the particular embodiment disclosed. Further, the embodiment described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A movable body control apparatus comprising:
a contact detector configured to detect a contact between a movable body and an object, the contact detector outputting a signal when detecting the contact therebetween;
an object-removable judging portion inputted with the signal and configured to distinguish the contact of the object against the movable body from a removable of the object from the movable body, and to judge the removable of the object, the distinction and judgment being implemented based upon a characteristic of variations in the signal outputted from the contact detector; and
an movement-controlling portion for automatically moving the movable body in the same direction as a direction in which the movable body is moving when the object-removable judging portion judges the removable of the object while the movable body is moving.

2. A movable body control apparatus according to claim 2, wherein
the characteristic of variations in the signal outputted from the contact detector includes variations in a level of the signal outputted from the contact detector, and the object-removable judging portion judges the contact of the object against the movable body when the level of the signal varies to a negative level and judges the removable of the object when the level of the signal varies to a positive level.

3. A movable body control apparatus according to claim 1, wherein
the characteristic of variations in the signal outputted from the contact detector includes variations in polarity of the signal, and the object-removable judging portion judges the removable of the object when the signal varies in a polar direction, the polar direction which is opposite to a polar direction in which the signal varies upon the contact.

4. A movable body control apparatus according to claim 2, wherein
the object-removable judging portion judges the removable of the object based upon the variations in the level of the signal and based upon a comparison between the level of the signal and a predetermined threshold level.

5. A movable body control apparatus according to claim 3, wherein
the object-removable judging portion judges the removable of the object based upon the variations in polarity of the signal and based upon a comparison between the level of the signal and a predetermined threshold level.

6. A movable body control apparatus according to claim 1, wherein
the contact detector is a piezoelectric sensor having flexibility and arranged at an edge of the movable body.

7. A movable body control apparatus according to claim 2, wherein
the contact detector is a piezoelectric sensor having flexibility and arranged at an edge of the movable body.

8. A movable body control apparatus according to claim 3, wherein
the contact detector is a piezoelectric sensor having flexibility and arranged at an edge of the movable body.

9. A movable body control apparatus according to claim 4, wherein
the contact detector is a piezoelectric sensor having flexibility and arranged at an edge of the movable body.

10. A movable body control apparatus according to claim 5, wherein
the contact detector is a piezoelectric sensor having flexibility and arranged at an edge of the movable body.

11. A movable body control apparatus according to claim 1, wherein
the movable body is an opening and closing member for use in a vehicle and mounted on the vehicle.

12. A movable body control apparatus according to claim 11, wherein
the opening and closing member for use in the vehicle includes at least one of a slide door, a rear door, a trunk lid, a lifting window, a sunroof and an opening wing for a luggage.

13. A movable body control apparatus according to claim 1, further comprising:
a movable body-operating portion configured to move the movable body automatically, and wherein
the movement-controlling portion controls the movable body-operating portion to automatically move the movable body in the same direction as the direction in which the movable body is moving when the object-removable judging portion judges the removable of the object while the movable body is moving.

14. A method of controlling a movable body, comprising the steps of:
detecting a contact between a movable body and an object based on a signal outputted from a contact detector;
distinguishing the contact of the object against the movable body from a removal of the object from the movable body based upon a characteristic of variations in the signal;
judging the removable of the object based upon the characteristic of variations in the signal; and
automatically moving the movable body in the same direction as a direction in which the movable body is moving when the object-removable judging portion judges the removable of the object while the movable body is moving.
